(19) United States
(12) Patent Application Publication
(10) Pub. No.: US 2012/0059137 A1
(43) Pub. Date: Mar. 8, 2012

(54) MONODISPERSE CHLOROMETHYLSTYRENE POLYMER AND PRODUCING METHOD THEREOF

(75) Inventors: Riina Kambara, Yamagata (JP); Hideharu Mori, Yamagata (JP); Takeshi Endo, Fukuoka (JP); Shigeaki Yonemori, Kanagawa (JP)

(73) Assignee: AGC SEIMI CHEMICAL CO., LTD., CHIGASAKI-SHI (JP)

(21) Appl. No.: 13/319,962

(22) PCT Filed: May 10, 2010
(86) PCT No.: PCT/JP10/57901

§ 371 Date: Nov. 10, 2011

(30) Foreign Application Priority Data
May 11, 2009 (JP) 2009-114766

(51) Int. Cl. C08F 12/18

(52) U.S. Cl. 526/293

(57) ABSTRACT

Provided is a monodisperse polymer of chloromethylstyrene as a bifunctional compound. Chloromethylstyrene is purified to a purity of at least 99% and polymerized preferably using a RAFT reagent.

### TECHNICAL FIELD

The present invention relates to a particularly high-molecular-weight and monodisperse chloromethylstyrene polymer which is useful as a functional polymer, and a method of producing the same.

### BACKGROUND ART

Chloromethylstyrene (hereinafter abbreviated as “CMS”) is a highly reactive bifunctional compound containing both vinyl group and chloromethyl group. By making use of its reactivity and structure, CMS is widely used for various polymer materials such as resist materials, ion-exchange membranes, ion-exchange resins, antistatic agents, polymer modifiers, flocculants, dispersants, surface modifiers and polymeric surfactants.

In the meantime, in the field of the resist materials, it is necessary to control the molecular weight and the molecular weight distribution of a base polymer in each of the resist materials in order to increase the resist resolution and degree of development. Living polymerization has heretofore been known as one of techniques for obtaining base polymers in which the polydispersity index represented by weight-average molecular weight/number-average molecular weight (Mw/Mn) is small. For example, it is described that, in the case of polymerizing p-methoxymethoxy-α-methylstyrene, a monodisperse polymer having a polydispersity index of 1.01 to 1.50 is obtained by living anionic polymerization using an organic metal compound as the polymerization initiator (see Patent Literature 1).

Living radical polymerization by means of reversible addition-fragmentation chain transfer (hereinafter abbreviated as “RAFT”) of a vinyl compound which uses any of dithioesters (referred to as “RAFT reagent”) for the chain transfer agent is known (see Patent Literature 2). This literature specifically illustrates monodisperse polymers in many polymerization examples of acrylates and styrenes but does not describe bifunctional styrenes and their polymerization examples as for the vinyl compound.

### CITATION LIST

### Patent Literature

Patent Literature 1: JP 06-65317 A
Patent Literature 2: WO 98/1478

### SUMMARY OF INVENTION

### Technical Problems

In living polymerization, the molecular weight and the polydispersity index of a polymer of interest can be theoretically derived from the charge into a reaction system, and particularly a polymer having a smaller polydispersity index than that obtained by other polymerization process can be obtained but the polymer obtained may actually have a larger polydispersity index than the theoretical value due to various factors. The inventors of the present invention have studied CMS and found that there is a limit to the monodisperse properties that can be achieved by merely applying a conventional polymerization process to CMS as a bifunctional compound, and the molecular weight also does not reach a theoretical value. Accordingly, an object of the present invention is to provide a CMS polymer which may have a molecular weight equivalent to the theoretical molecular weight and consistently exhibits favorable monodisperse properties regardless of the molecular weight, and a method of producing such a CMS polymer.

### Solution to Problems

The inventors of the present invention have found that a CMS polymer of the above object can be produced and obtained at a high yield by using in the polymerization a high-purity CMS purified to a purity of 99% or more.

Accordingly, the present invention provides a method of producing a polymer including a chloromethylstyrene repeating unit which includes polymerizing a chloromethylstyrene with a purity of 99% or more.

The polymerization is preferably one using a RAFT reagent.

The chloromethylstyrene is one purified in the purification process including, for example, adsorption chromatography.

In the present invention, the monomer conversion in the polymerization correlates with the time and a molecular weight close to a theoretical value can also be achieved in a high-molecular-weight polymer, and the high-molecular-weight polymer can be produced at a high yield.

Another aspect of the present invention is a polymer comprising a segment of repeating unit which is derived from a chloromethylstyrene and has a polydispersity index (Mw/Mn) of 1.10 to 1.23.

The chloromethylstyrene is, for example, p-chloromethylstyrene. The polymer preferably has a number-average molecular weight (Mn) of 10,000 or more.

### Advantageous Effects of Invention

The polymerization method provided by the present invention enables the molecular weight and the molecular weight distribution to be controlled and facilitates the control of the structure and physical properties of polymers. In particular, a CMS polymer with a narrow molecular weight distribution can be obtained and therefore this method can be particularly applied to various uses such as a base polymer of a resist material which requires higher definition.

### BRIEF DESCRIPTION OF DRAWINGS

FIG. 1 schematically shows TLC of purified p-CMSs; (a): CMS2 obtained by precision distillation, (b): column-purified CMS2 (CMS3).

FIG. 2 is a ¹H-NMR chart of commercially available p-CMS (CMS1), CMS2 obtained by precision distillation and column-purified CMS2 (CMS3).

FIG. 3 shows a gas chromatograph of commercially available p-CMS (CMS1).

FIG. 4 shows a gas chromatograph of CMS2 obtained by precision distillation.

FIG. 5 shows a gas chromatograph of column-purified CMS2 (CMS23).

FIG. 6 shows SEC curves in the polymerization; (a): Example 1, (b): Comparative Example 1.

FIG. 7 shows graphs of variations with time of the monomer conversion and the CMS concentration during the polymerization; (a): Example 1, (b): Comparative Example 1.

FIG. 8 shows graphs of the relationship of the number-average molecular weight (Mn) and the polydispersity index (Mw/Mn) of the polymers with the conversion; (a): Example 1, (b): Comparative Example 1.

FIG. 9 is a graph showing variations with time of the monomer conversion and the CMS concentration in the polymerization of Example 2.

FIG. 10 is a graph showing the relationship of the number-average molecular weight (Mn) and the polydispersity index (Mw/Mn) with the conversion in Example 2.

FIG. 11 shows SEC curves in the polymerization of Example 3.

### DESCRIPTION OF EMBODIMENTS

In the present invention, a CMS with a purity of 99% or more is used in the CMS polymerization.

Specifically, the CMS may be p-chloromethylstyrene (hereinafter abbreviated as “p-CMS”), m-chloromethylstyrene or a mixture thereof. Of these, p-CMS is preferred.

Several processes such as gas-phase process and liquid-phase process are known to synthesize the CMS and the CMS may be synthesized by any of these processes. The CMS easily contains various impurities generated as by-products during the synthesis process. For example according to the contact process between an alkyl vinyl aromatic compound and a halogen gas (gas-phase process) which is a conventional process for preparing a halogenated alkyl vinyl aromatic compound, chlorine-containing by-products such as phenyldichloromethylstyrene, (dichloromethyl)ethylbenzene and trichlorinated styrene are generated (see U.S. Pat. No. 2,981,758).

Therefore, the CMS is usually purified by distillation after the synthesis.

The commercially available CMS is a commercial product obtained by purifying to a purity of about 90% through distillation and a product with a high purity of 96% is also commercially available. Exemplary commercial products include CMS-P and CMP-14 (AGC Seimi Chemical Co., Ltd.), vinylbenzyl chloride (VBC; The Dow Chemical Company) and 4-(chloromethyl)styrene with a purity of more than 90% (Tokyo Chemical Industry Co., Ltd.).

A high purity CMS that may be used in the present invention is obtained by purifying any of such common synthetic compounds or commercial products (hereinafter referred to as “crude CMS”) to a purity of 99% or more.

In the present invention, exemplary impurities which are preferably removed from the CMS include α-chlorostyrene or β-chlorostyrene in which chlorine is attached to vinyl group, the by-products in the gas-phase process, methylstyrene, m-formylstyrene, dichloromethylstyrene and styrene derivatives having a substituent other than chloromethyl.

The CMS used in the present invention has a purity of at least 99% and preferably at least 99.5%. The high purity CMS is desirably colorless.

A large part of the impurities are removed by distillation following the synthesis but sufficient purification is not achieved only by the distillation. Particularly, the CMS obtained after the precision distillation (distillation under reduced pressure) of the crude CMS is, for example, colored with yellow. Therefore, the high purity CMS is desirably obtained by performing purification including adsorption chromatography.

A common chromatography using a silica gel stationary phase can be applied to perform adsorption chromatography. Various organic solvents such as hexane may be used for the mobile phase.

In cases where the crude CMS has a low purity, it is efficient to perform purification by means of distillation under reduced pressure prior to adsorption chromatography. Distillation under reduced pressure is typically performed at 3 mmHg and 85° C.

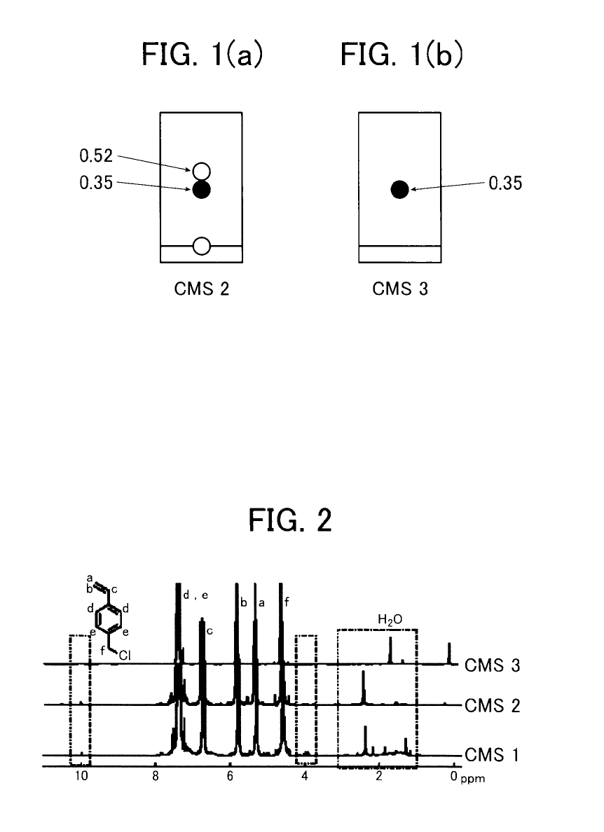

More specifically, as will be described later, impurities contained in the CMS to be purified by adsorption chromatography are confirmed by silica gel thin-layer chromatography (TLC, developing solvent: hexane) of p-CMS as a spot at an Rf value (0.52) different from the Rf value (0.35) of p-CMS and as a non-mobile spot (see FIG. 1(a)), whereas the CMS purified by adsorption chromatography has no other spot than p-CMS (see FIG. 1(b)).

In the present invention, the purity of the CMS has a value determined as a peak ratio of the target CMS peak (20 minutes) measured by gas chromatography (column filler: silicone SE-30) to all peaks except the peak (2.5 minutes) of acetone used as the solvent.

In the present invention, the highly purified CMS as described above is used in the polymerization. It is possible to use a known process for the polymerization and an atom transfer radical process and a RAFT process are preferred in terms of controlling the molecular weight and molecular weight distribution. RAFT polymerization using no heavy metal compound is particularly preferred. The polymerization of the CMS is described below based on the RAFT process.

A dithioester having a —C(═S)S— structure is used as the RAFT reagent. Specific examples of the compound are described in Patent Literature 2 (supra), which is incorporated herein by reference.

The RAFT reagent that may be preferably used in the present invention is represented by the following general formula:

Ar—C(═S)—S—C(R¹,R²,R³)

wherein

Ar is a monovalent aromatic hydrocarbon group which may be substituted by a halogen atom, or two or more rings may be condensed;

R¹ and R² are each independently a hydrogen atom or an alkyl group having 1 to 3 carbon atoms; and

R³ is a phenyl group, a cyano group, an alkyl group having 1 to 3 carbon groups or COOR⁴ where R⁴ is a hydrogen atom or an alkyl group having 1 to 3 carbon atoms.

Examples of Ar include phenyl group, naphthyl group and anthryl group. These groups may be substituted by halogen atoms such as fluorine atom and chlorine atom.

Of these, Ar is preferably a phenyl group.

R¹ and R² are each independently a hydrogen atom or a methyl group. In particular in a preferred embodiment, R¹ and R² are each a hydrogen atom or one of them is a hydrogen atom and the other is a methyl group.

R³ is preferably a phenyl group.

Specific examples of the RAFT reagent are shown below and benzyl dithiobenzoate (CTA1), 1-phenylethyl dithiobenzoate (CTA2) and the like are preferably used.

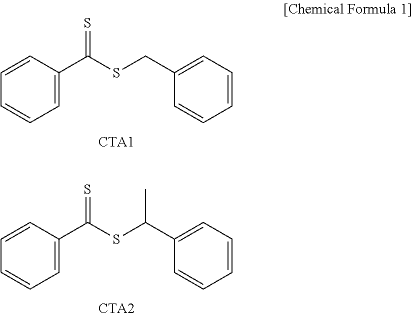

These compounds can be synthesized according to the processes described in the following literatures.

### (Literatures for the Synthesis of CTA1)

1) Chong, Y. K.; Krstina, J.; Le, T. P. T.; Moad, G.; Postma, A.; Rizzardo, E.; Thang, S. H. Macromolecules 2003, 36, 2256-2272.
2) Mori, H.; Iwaya, H.; Nagai, A.; Endo, T. Chemical Communications (Cambridge) 2005, 4872-4874.

### (Literatures for the Synthesis of CTA2)

1) Chiefari, J.; Chong, Y. K.; Ercole, F.; Krstina, J.; Jeffery, J.; Le, T. P. T.; Mayadunne, R. T. A.; Meijs, G. F.; Moad, C. L.; Moad, G.; Rizzardo, E.; Thang, S. H. Macromolecules 1998, 31, 5559-5562.
2) Perrier, S.; Barner-Kowollik, C.; Quinn, J. F.; Vana, P.; Davis, T. P. Macromolecules 2002, 35, 8300-8306.

Examples of the initiator include organic peroxides such as benzoyl peroxide and azobis compounds such as 2,2′-azobisisobutylonitrile, and 2,2′-azobisisobutylonitrile is particularly preferred.

In the RAFT polymerization, the following approximate expression is usually used to calculate a theoretical value Mn (theor) of the number-average molecular weight of a polymer to be produced.

Mₙ(theor)=([Monomer]₀/[RAFT]₀)×M_{Monomer}×conversion+M_{RAFT}

wherein
[Monomer]₀: initial concentration of the monomer;
[RAFT]₀: initial concentration of the RAFT reagent;
M_{Monomer}: molecular weight of the monomer;
M_{RAFT}: molecular weight of the RAFT reagent; and
Conversion: conversion.

Therefore, the amounts of the CMS monomer and RAFT reagent to be charged may be appropriately determined according to the molecular weight to be reached. The molar ratio of [RAFT]/[CMS] is not particularly limited but is, for example, from 10 to 10,000 and preferably from 20 to 1,000.

The preferred amount of initiator to be used varies with the concentrations of the RAFT reagent and CMS. The initiator (I) is usually used in an amount which is equal to or smaller than that of the RAFT reagent (RAFT) and the charge ratio (molar ratio) of [RAFT]/[I] is preferably from 1 to 30 and more preferably from 2 to 10.

In an example in which a high-molecular-weight polymer with a narrow molecular weight distribution is obtained, the charge ratio (molar ratio) between the initiator (I), the RAFT reagent (RAFT) and CMS in the present invention as represented by [I]:[RAFT]:[CMS] is preferably from 1:2:500 to 1:2:2,000.

The CMS polymerization temperature is usually from 30° C. to 150° C. and more preferably from 60° C. to 100° C.

The CMS may be polymerized in the presence or absence of a solvent. The CMS is preferably polymerized in the absence of a solvent in order to increase the polymerization rate but in the presence of a solvent in order to obtain a high-molecular-weight polymer.

Examples of the polymerization solvent include aromatic hydrocarbons such as toluene, xylene and chlorobenzene; aliphatic hydrocarbons such as heptane, hexane and octane; acetates such as ethyl acetate, butyl acetate and isobutyl acetate; ketones such as methyl ethyl ketone and methyl isobutyl ketone; aliphatic alcohols such as isopropanol, normal butanol and isobutanol; and aprotic solvents such as N,N-dimethylformamide, N,N-dimethylacetamide, acetonitrile, dimethyl sulfoxide, alkyl ether, tetrahydrofuran, diethyl ether and dioxane. Toluene, chlorobenzene and 1,4-dioxane are preferred.

The solvent is preferably used in a weight ratio to the monomer used of 0.5 to 10 and more preferably 1 to 3.

In the present invention, a high-molecular-weight polymer can be synthesized at a high yield, which shows that polymerization of particularly a highly purified CMS enables the radical concentration to be kept constant while also suppressing the chain transfer reaction. As will be shown in Examples, a highly purified CMS with a purity of at least 99% is used for the polymerization to significantly increase the conversion with time. Therefore, a high-molecular-weight polymer can be obtained at a high yield. It is also possible to provide a high-molecular-weight polymer which is monodisperse regardless of the molecular weight and has a small molecular weight distribution.

The polydispersity index (Mw/Mn) of the segment of CMS repeating unit which is achieved by the present invention is preferably from 1.10 to 1.23 and more preferably from 1.10 to 1.21.

Such a monodisperse segment of CMS repeating unit may form a polymer only composed of this segment, that is, a CMS homopolymer or make up a part of a block copolymer.

The weight-average molecular weight Mw of the polymer as used in the specification is the standard polystyrene equivalent molecular weight measured by gel permeation chromatography (GPC) using a styrene-divinylbenzene copolymer shown in Examples as the filler.

### EXAMPLES

The present invention is described below more specifically by way of examples. The following examples illustrate the present invention without limiting it.

The measurement devices and conditions used in the examples are shown below:

### [¹H-NMR]

JEOL JNM-ECX400 (400 MHz; JEOL Ltd.), solvent for measurement: CDCl₃

### [Gas Chromatography (GC)]

GC-2014 (Shimadzu Corporation)

Column filler: Silicone SE-30 30%

Injection temperature: 200° C.

Detection temperature: 200° C.

### [GPC]

Tosoh DP-8020 pump with a Viscotek TDA model-301 triple detector array

Column (exclusion limit molecular weight): TSKgel-GMH_{XL}(4×10⁸), -G4000H_{XL}(4×10⁵), -G3000H_{XL}(6×10⁴) and -G2500H_{XL}(2×10⁴) available from Tosoh Corporation (each 30 cm)

Guard column: TSKguardcolumnH_{XL}-H (4 cm)

Mobile phase: THF (flow rate: 1.0 mL/min)

Detector: RI

### Purification Example 1

### Purification of p-CMS

A commercially available p-CMS (4-(chloromethyl)styrene from Tokyo Chemical Industry Co., Ltd., purity: more than 90%) (hereinafter abbreviated as “CMS1”) was subjected to precision distillation (3 mmHg, 85° C.) under reduced pressure.

Then, the thus distilled compound (hereinafter abbreviated as “CMS2”) was purified by column chromatography (silica gel 60; developing solvent: hexane). The final purified product is hereinafter abbreviated as “CMS3.”

CMS2 obtained by distillation was yellow, whereas CMS3 obtained by column purification was colorless and transparent. The recovery rate in each step and the purity determined from GC are shown in Table 1.

CMS2 and CMS3 were subjected to thin-layer chromatography (TLC) (developing solvent: hexane, detector: UV). The development pattern of TLC is schematically shown in FIG. 1 (a: CMS2, b: CMS3).

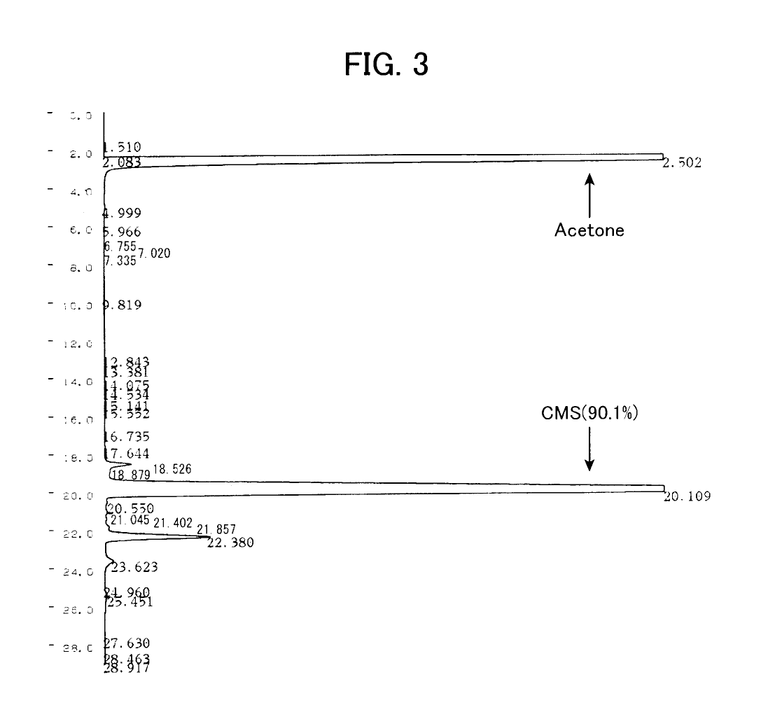

FIG. 2 shows a ¹H-NMR chart of CMS1 to CMS3 in order of from CMS1 to CMS3 from the lower side.

As shown in FIG. 1, impurities (Rf value: 0.52) detected by TLC of CMS2 obtained by distillation (see FIG. 1a) are not present in TLC of CMS3 obtained by column purification (see FIG. 1b), which shows that the impurities which could not be removed by precision distillation are removed by column purification.

According to ¹H-NMR shown in FIG. 2, peaks of the impurities at around 4 ppm and 10 ppm which could not be removed by precision distillation disappear almost completely, which shows that the column purification is effective to remove impurities containing at least yellow-colored matter.

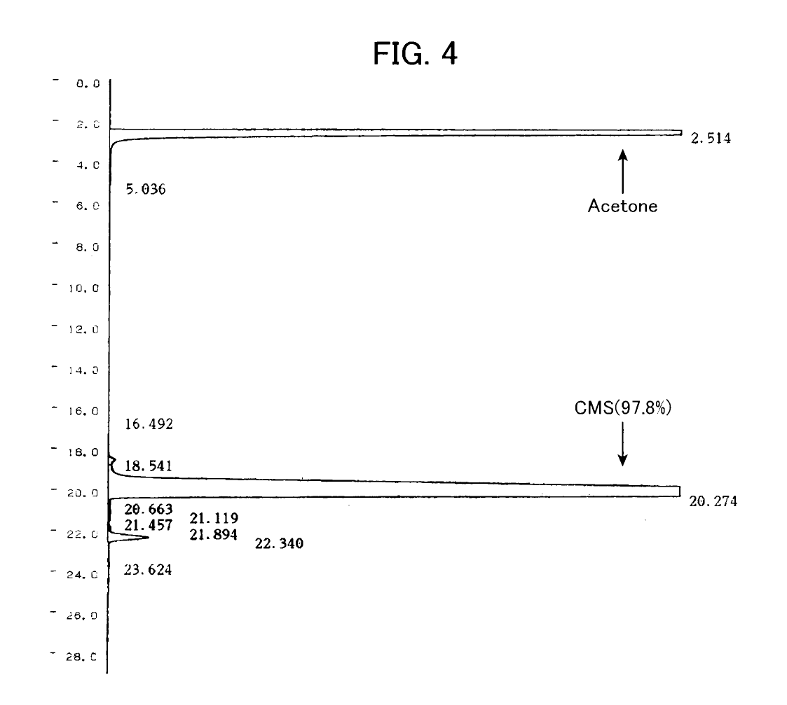

GC charts of CMS1 to CMS3 are shown in FIG. 3 to FIG. 5, respectively.

The CMS purity was calculated from the ratio between the target CMS peak (20 minutes) and all the peaks except the peak (2.5 minutes) of acetone used as the solvent.

TABLE 1

| CMS | | Recovery rate (%) | Purity (%) |
|---|---|---|---|
| 1 | Commercially available product | — | 90.1 |
| 2 | Obtained by precision | 65 | 97.8 |
| | distillation | | |
| 3 | Obtained by precision | 21 | 99.6 |
| | distillation and column | | |
| | purification | | |

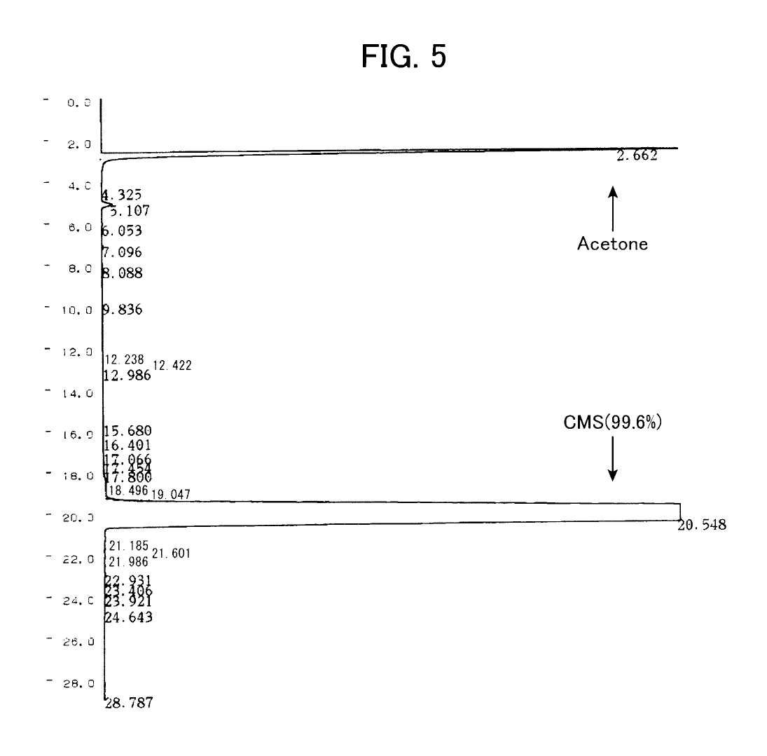

FIG. 3 to FIG. 5 also showed that impurity peaks in the vicinity of p-CMS (retention time) as seen in the commercially available CMS1 decreased, no peak was detected in FIG. 5 and CMS3 after the column purification had the highest purity.

### Example 1

### Polymerization of High Purity p-CMS

To a polymerization tube were added AIBN (3.20 mg, 0.02 mmol) as the initiator, benzyl dithiobenzoate (CTA1, synthetic compound) (13.8 mg, 0.04 mmol) as the chain transfer agent, and CMS3 (0.61 g, 4.00 mmol) which is the high purity p-CMS obtained in Purification Example 1. Vacuum degassing was performed three times and the tube was sealed. Then, the reaction was allowed to take place at 60° C. for 48 hours. The polymerization was terminated by cooling with liquid nitrogen.

The resulting polymer was diluted with acetone and reprecipitated with methanol to purify the target. The yield was 74% (0.45 g).

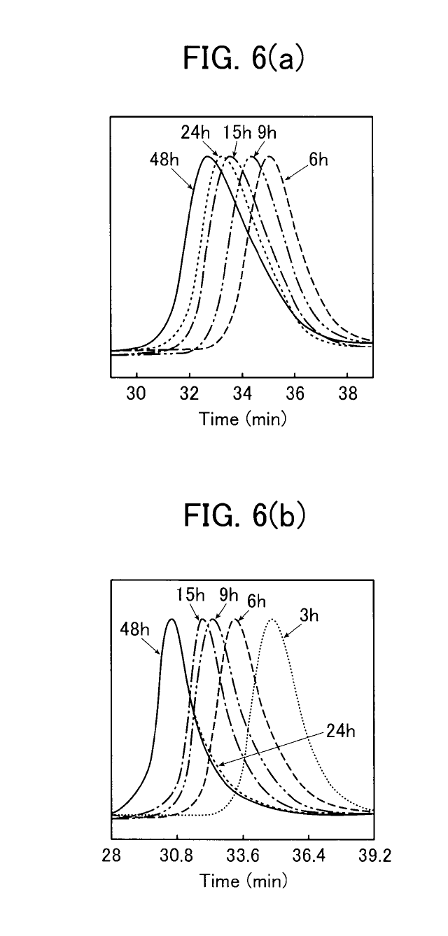

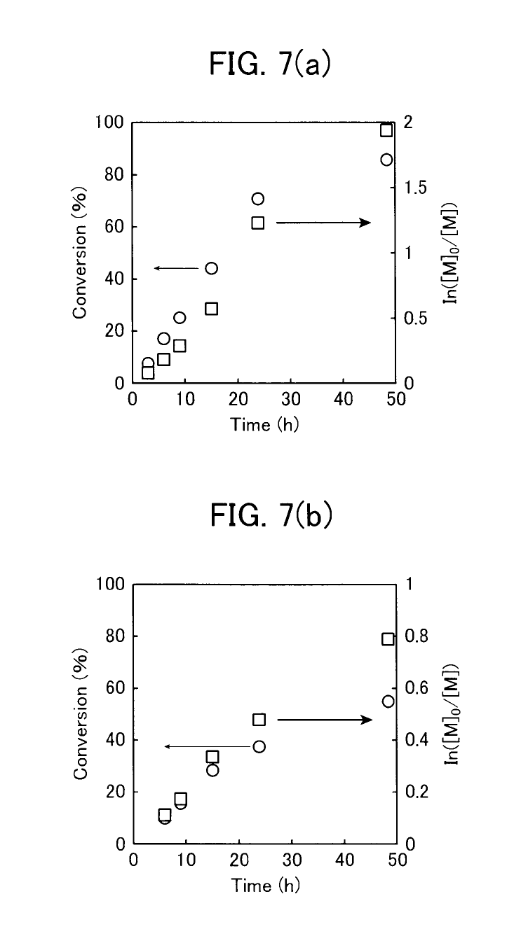

The reaction solution which was in the course of polymerization was subjected to GPC with time to measure the molecular weight. The SEC curves are shown in FIG. 6(a). ¹H-NMR of each reaction solution was measured as described below to determine the monomer conversion and CMS concentration during the polymerization. FIG. 7(a) shows the conversion (O) and the CMS concentration (□).

### [Conversion]

The conversion was calculated by the integral ratio of vinyl group peak of the monomer at 5.2 ppm (d, 1H, —CH═CH₂) to methylene attached to chloride of the polymer and monomer at 4.5 (s, 2H, C—CH₂—Cl).

### [CMS Concentration]

The CMS concentration was determined from:

In([M]₀/[M])

where [M]₀: initial concentration of the monomer; and

[M]: monomer concentration after a predetermined period of time.

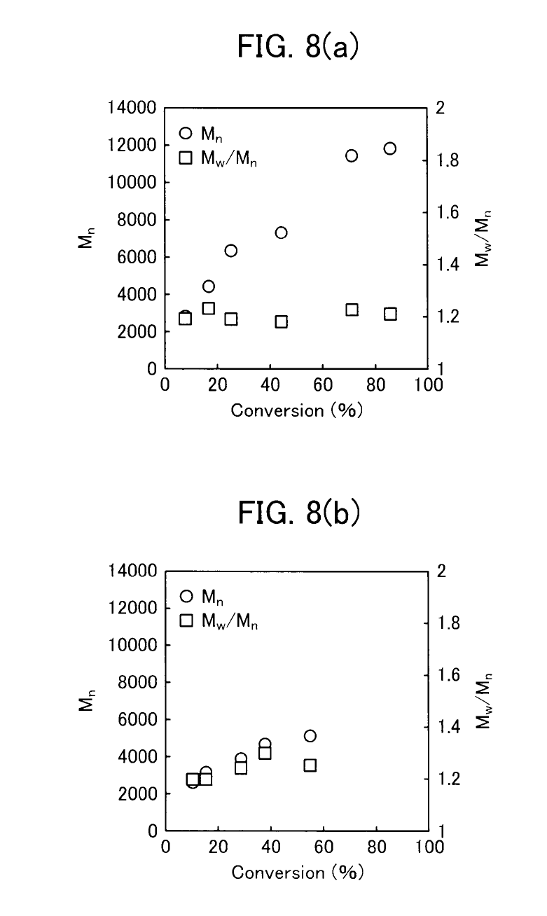

FIG. 8(a) shows the polydispersity index (Mw/Mn) (□) and the number-average molecular weight Mn (O) with respect to the conversion of each reaction solution.

### Comparative Example 1

### Polymerization of p-CMS

To a polymerization tube were added AIBN (1.60 mg, 0.01 mmol) as the initiator, benzyl dithiobenzoate (CTA1) (6.90 mg, 0.02 mmol) as the chain transfer agent, and CMS2 (obtained by distillation in Purification Example 1) (1.53 g, 0.02 mmol). Vacuum degassing was performed three times and the tube was sealed. Then, the reaction was allowed to take place at 60° C. for 48 hours. The polymerization was terminated by cooling with liquid nitrogen. The resulting polymer was reprecipitated with methanol to purify the target. The yield was 34% (0.52 g).

GPC and ¹H-NMR of the reaction solution were measured with time as in Example 1. FIG. 6(b) shows SEC curves, FIG. 7(b) shows the conversion (O) and the CMS concentration (□) determined by the same method as in Example 1, and FIG. 8(b) shows the polydispersity index (Mw/Mn) (□) and the number-average molecular weight Mn (O) with respect to the conversion.

Example 1 was compared with Comparative Example 1.

As shown in FIG. 7, the conversion and the molecular weight reached the plateau as shown in (b) in the polymerization in Comparative Example 1 using CMS2 obtained by distillation, whereas both of the conversion and the molecular weight correlated with the polymerization time as shown in (a) in the polymerization in Example 1 using the high purity CMS3 obtained by column purification. The conversion after 48 hours was 55% in Comparative Example 1 and as high as 86% in Example 1.

As shown in FIG. 8(a), in Example 1, the polymer showed a consistently small Mw/Mn value, the polymer obtained had a narrow molecular weight distribution and the molecular weight increased with time, which showed that a high-molecular-weight, monodisperse polymer can be produced at a high yield.

The measurement results in Example 1 and Comparative Example 1 are shown in Table 2.

TABLE 2

| | | | | | Mₙ | Mₙ | M_{w}/Mₙ |
|---|---|---|---|---|---|---|---|
| | Sample | Polymerization | | Conversion | (theoretical | (analytical | (analytical |
| | No. | time (h) | Yield (%) | (%) | value) | value) | value) |
| Example 1 | 1 | 3 | 4 | 8 | 1400 | 2800 | 1.19 |
| | 2 | 6 | 14 | 17 | 2800 | 4400 | 1.23 |
| | 3 | 9 | 21 | 25 | 4100 | 6300 | 1.19 |
| | 4 | 15 | 44 | 44 | 7000 | 7300 | 1.18 |
| | 5 | 24 | 62 | 71 | 11000 | 11400 | 1.23 |
| | 6 | 48 | 74 | 86 | 13300 | 11800 | 1.21 |
| Comparative | 1 | 6 | 6 | 10 | 1800 | 2600 | 1.2 |
| Example 1 | 2 | 9 | 14 | 15 | 2600 | 3200 | 1.2 |
| | 3 | 15 | 21 | 29 | 4600 | 3900 | 1.24 |
| | 4 | 24 | 24 | 38 | 6000 | 4700 | 1.3 |
| | 5 | 48 | 34 | 55 | 8600 | 5100 | 1.25 |

### Example 2

### Polymerization of High Purity p-CMS

To a polymerization tube were added AIBN (3.20 mg, 0.02 mmol) as the initiator, 1-phenylethyl dithiobenzoate (CTA2, synthetic compound) (10.3 mg, 0.04 mmol) as the chain transfer agent, and CMS3 (high purity p-CMS) (0.61 g, 4.00 mmol) obtained in Purification Example 1. Vacuum degassing was performed three times and the tube was sealed. Then, the reaction was allowed to take place at 60° C. for 48 hours. The polymerization was terminated by cooling with liquid nitrogen. The resulting polymer was diluted with acetone and reprecipitated with methanol to purify the target.

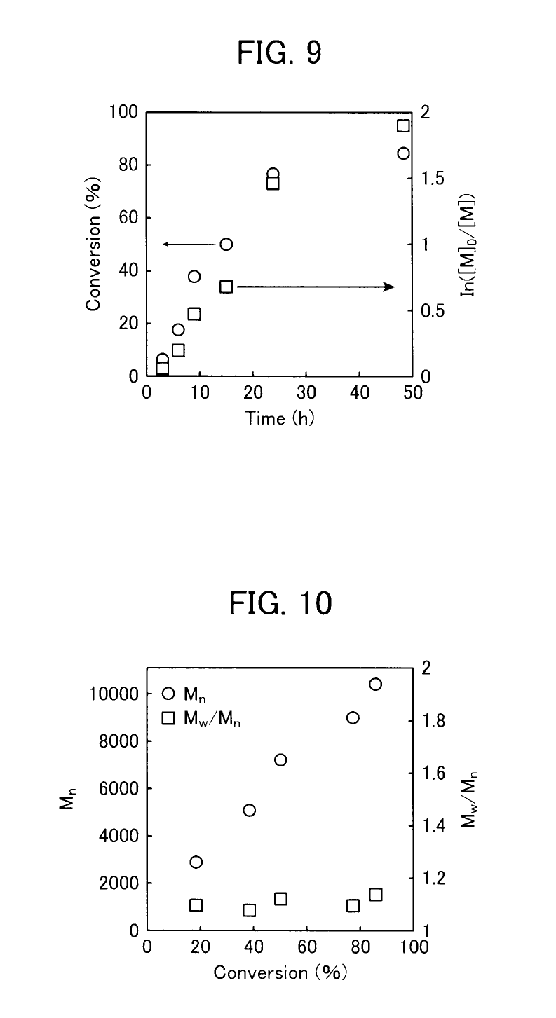

GPC and ¹H-NMR of each reaction solution were measured as in Example 1 at predetermined time intervals to determine the monomer conversion and the CMS concentration. FIG. 9 shows the conversion (O) and the CMS concentration (□). FIG. 10 shows the correlation of the conversion with the polydispersity index (Mw/Mn) (□) and the number-average molecular weight Mn (O).

The conversion and the yield after 48 hours were 81% and 73, (0.46 g), respectively.

As shown in FIG. 9, both of the conversion and the molecular weight correlated with the polymerization time as in Example 1 regardless of the type of chain transfer agent. As is seen from FIG. 10, the molecular weight (Mn) increased with time, and the Mw/Mn had a smaller value than in Example 1, which showed that the molecular weight distribution was narrower.

### Example 3

### Polymerization of High Purity p-CMS

Polymerization was carried out in the same manner as in Example 2 except that the charge ratio of AIBN to CTA2 ([AIBN]₀/[CTA2]₀) was set to 1/2 and the charge ratio of CMS3 to CTA2 (shown by [CMS]₀/[CTA2]₀) in the Table) was changed to a value shown Table 3.

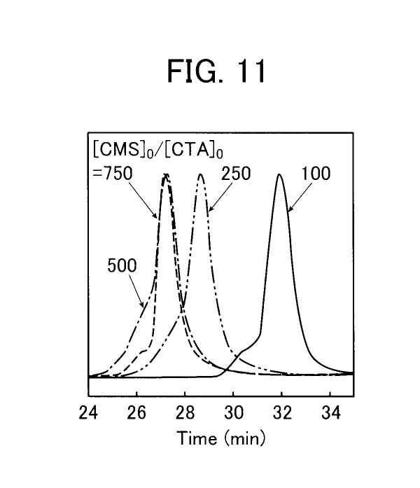

In the case where the polymer had a high viscosity and it was difficult to add dropwise the polymer to methanol during the reprecipitation, acetone was added to the polymerization solution to reduce the viscosity and the polymerization solution was added dropwise. ¹H-NMR was measured for each polymer to confirm the structure and GPC was measured. The results are shown in Table 3 and FIG. 11.

TABLE 3

| | | | | M_{w} | Mₙ | M_{w}/Mₙ |
|---|---|---|---|---|---|---|
| | [CMS]/ | Yield | conversion | (theoretical | (analytical | (analytical |
| No. | [CTA] | (%) | (%) | value) | value) | value) |
| 1 | 100 | 72 | 77 | 12000 | 9000 | 1.1 |
| 2 | 250 | 87 | 95 | 36500 | 31800 | 1.22 |
| 3 | 500 | 91 | 92 | 70500 | 60800 | 1.34 |
| 4 | 750 | 71 | 71 | 81500 | 55500 | 1.21 |

These results confirmed that the molecular weight distribution was narrow even when the charge ratio between the initiator (I), RAFT reagent (CTA) and CMS was changed in the polymerization of the CMS according to the invention. Particularly, it was revealed that the charge ratio between [I], [CTA] and [CMS] of 1:2:1500 was preferred because a high-molecular-weight polymer having a molecular weight which is also close to a theoretical value could be obtained.

1. A polymer, comprising a segment of repeating unit which is derived from a chloromethylstyrene and has a polydispersity index (Mw/Mn) of 1.10 to 1.23.

2. The polymer of claim 1, wherein the chloromethylstyrene is p-chloromethylstyrene.

3. The polymer of claim 1, having a number-average molecular weight (Mn) of 10,000 or more.

4. A method of producing the polymer of claim 1, the method comprising polymerizing a chloromethylstyrene with a purity of at least 99% to obtain the segment of repeating unit.

5. The method of claim 4, wherein the polymerizing is with a RAFT reagent.

6. The method of claim 4, wherein the chloromethylstyrene is purified in a purification process comprising adsorption chromatography.

7. The polymer of claim 2 having a number-average molecular weight (Mn) of 10,000 or more.

8. A method of producing the polymer of claim 2, the method comprising polymerizing a chloromethylstyrene with a purity of at least 99% to obtain the segment of repeating unit.

9. The method of claim 8, wherein the polymerizing is with a RAFT reagent.

10. A method of producing the polymer of claim 3, the method comprising polymerizing a chloromethylstyrene with a purity of at least 99% to obtain the segment of repeating unit.

11. The method of claim 10, wherein the polymerizing is with a RAFT reagent.

12. The method of claim 5, wherein the chloromethylstyrene is purified in a purification process comprising adsorption chromatography.

13. The method of claim 8, wherein the chloromethylstyrene is purified in a purification process comprising adsorption chromatography.

14. The method of claim 10, wherein chloromethylstyrene is purified in a purification process comprising adsorption chromatography.
